(19) United States
(12) Patent Application Publication
(10) Pub. No.: US 2024/0202184 A1
(43) Pub. Date: Jun. 20, 2024

(54) METHODS AND SYSTEMS FOR MANAGING LIST DATA STRUCTURES IN EVENT-DRIVEN SYSTEMS

(71) Applicant: Shopify Inc., Ottawa (CA)

(72) Inventors: Janelle Louise CHUNG, Vancouver (CA); Gaurav KESWANI, Sunnyvale, CA (US); Jovana MANDIC, Toronto (CA)

(21) Appl. No.: 18/068,497

(22) Filed: Dec. 19, 2022

(51) Int. Cl. G06F 16/23

(52) U.S. Cl. CPC G06F 16/2379; G06F 16/2358

(57) ABSTRACT

Methods and systems for managing list data structures in an event-driven system are disclosed. One or more list data structures store notifications for a plurality of event consumers. One or more real-time event streams are monitored and, based on the monitoring, a first event is identified. One or more list entries are added to at least one list data structure of the one or more list data structures, to notify two or more event consumers of the plurality of event consumers of the first event. The one or more real-time event streams are further monitored, and, based on the monitoring, a further event associated with the first event is identified. Responsive to identifying the further event associated with the first event, the one or more list entries are updated to reflect the further event.

### FIELD

The present disclosure is related to event-driven systems, in particular managing list data structures in event-driven systems, including event-driven distributed systems.

### BACKGROUND

In an event-driven system, different system modules (also referred to as event producers) may generate system events (also referred to simply as events). Event consumers are software functions or modules that are tasked with processing events as the events occur. Different event consumers may process (also referred to as consume) the same or different events.

### SUMMARY

A challenge occurs when there are two or more event consumers that are configured to process a given event in the same manner. When the given event occurs, those two or more event consumers might each attempt to process the same event in the same manner, without knowledge that another event consumer is also performing the same processing of the same event. This may result in instability in the event-driven system (e.g., due to multiple event consumers attempting to access the same data block) and/or wasted resources (e.g., due to redundant processing of the system event), among other disadvantages.

In a typical event-driven system, events can be generated by event producers at any time, and event consumers can process events as they occur, without requiring direct communications between event producers and event consumers. Event consumers do not need to communicate with each other and may each process the same event at different times (e.g., depending on other ongoing processes at each event consumer). This means the event producers and event consumers may all operate asynchronously within the same event-driven system. Asynchronous operation may help to improve efficiency and/or throughput of the event-driven system. However, there is an increased challenge in managing the operations of different event consumers because there may not be a clear dependency or hierarchy between event consumers.

In particular, there is a problem in how to notify one event consumer that a given event is already being processed by another event consumer (and thus the given event does not need to be processed again). Conventionally, event consumers do not produce their own events and do not communicate with each other. Thus, conventional event-driven systems may not have any manner of preventing redundant processing of the same event by two different event consumers. While some redundancy may be tolerable, as event-driven systems increase in size and complexity the occurrence of such redundancy also increases. The result may be significant inefficiencies, wasted computing resources and possibly increased system instability.

In various examples, the present disclosure describes systems and methods that enable an event-driven system to manage a list data structure that is used to notify multiple event consumers. In particular, a list entry is added to a list data structure in response to the presence of a first event in a real-time event stream in order to notify multiple event consumers. Then, the list entry in the list data structure can be updated to reflect a further event related to the first event. This enables the multiple event consumers, which were originally notified by the list entry, to be provided with updated information. In particular, the event consumers may be updated with information that the first event has been processed, thus avoiding redundant processing of the first event. This provides an advantage in improved efficiencies and reduced latency, by reducing redundancies and avoiding the need for event consumers to explicitly request an update. Other advantages of the present disclosure may be discussed further below.

In some examples, the present disclosure describes a computing system including: a physical memory storing one or more list data structures for storing notifications for a plurality of event consumers; and a processing unit configured to execute computer-readable instructions to cause the computing system to perform operations for managing the one or more list data structures. The operations include: monitoring one or more real-time event streams and, based on the monitoring, identifying a first event; adding, to at least one list data structure of the one or more list data structures, one or more list entries to notify two or more event consumers of the plurality of event consumers of the first event; further monitoring the one or more real-time event streams, and, based on the monitoring, identifying a further event associated with the first event; and responsive to identifying the further event associated with the first event, updating the one or more list entries to reflect the further event.

In any of the preceding examples, the one or more list entries may be added to at least two list data structures of the one or more list data structures, and updating the one or more list entries may include updating the one or more list entries across all of the at least two list data structures.

In any of the preceding examples, the operations may further include: identifying the two or more event consumers to be notified of the first event; and selecting the at least one list data structure to which the one or more list entries are added, based on identification of the two or more event consumers.

In any of the preceding examples, the one or more list entries may be added to the at least one list data structure in response to determination that the first event satisfies at least one defined list entry creation criterion.

In any of the preceding examples, at least one list entry of the one or more list entries may be updated to a complete status, and the at least one list entry may be removed from the at least one list data structure responsive to the complete status.

In any of the preceding examples, the one or more real-time event streams may contain events generated by any one or more of a plurality of distributed modules in communication with the computing system.

In any of the preceding examples, at least one of the plurality of distributed modules may be a third-party module external to and in communication with the computing system, and identifying the further event and updating the one or more list entries may be performed in absence of a query to the third-party module.

In any of the preceding examples, the first event may be associated with an online service of the computing system, the at least one list data structure may be associated with the online service, and the two or more event consumers may be associated with respective two or more user accounts associated with the online service.

In any of the preceding examples, a master list data structure may be associated with the online service, and each list data structure associated with a respective user account may be generated from the master list data structure.

In any of the preceding examples, the operations may further include: pushing the one or more list entries, to one or more computing devices associated with each of the two or more event consumers; and updating the one or more list entries may include pushing respective one or more updates of the one or more list entries to the one or more computing devices associated with each of the two or more event consumers.

In some examples, the present disclosure describes a computer-implemented method for managing one or more list data structures storing notifications for a plurality of event consumers, the method including: monitoring one or more real-time event streams and, based on the monitoring, identifying a first event; adding, to at least one list data structure of the one or more list data structures, one or more list entries to notify two or more event consumers of the plurality of event consumers of the first event; further monitoring the one or more real-time event streams, and, based on the monitoring, identifying a further event associated with the first event; and responsive to identifying the further event associated with the first event, updating the one or more list entries to reflect the further event.

In any of the preceding examples, the one or more list entries may be added to at least two list data structures of the one or more list data structures, and updating the one or more list entries may include updating the one or more list entries across all of the at least two list data structures.

In any of the preceding examples, the method may include: identifying the two or more event consumers to be notified of the first event; and selecting the at least one list data structure to which the one or more list entries are added, based on identification of the two or more event consumers.

In any of the preceding examples, the one or more list entries may be added to the at least one list data structure in response to determination that the first event satisfies at least one defined list entry creation criterion.

In any of the preceding examples, at least one list entry of the one or more list entries may be updated to a complete status, and the at least one list entry may be removed from the at least one list data structure responsive to the complete status.

In any of the preceding examples, the one or more real-time event streams may contain events generated by any one or more of a plurality of distributed modules, and identifying the further event and updating the one or more list entries may be performed in absence of a query to the plurality of distributed modules.

In any of the preceding examples, the first event may be associated with an online service, the at least one list data structure may be associated with the online service, and the two or more event consumers may be associated with respective two or more user accounts associated with the online service.

In any of the preceding examples, a master list data structure may be associated with the online service, and each list data structure associated with a respective user account may be generated from the master list data structure.

In any of the preceding examples, the method may further include: pushing the one or more list entries, to one or more computing devices associated with each of the two or more event consumers; updating the one or more list entries may include pushing respective one or more updates of the one or more list entries to the one or more computing devices associated with each of the two or more event consumers.

In some examples, the present disclosure describes a computer-readable medium storing instructions that, when executed by a processor of a computing system, cause the computing system to perform operations for managing one or more list data structures storing notifications for a plurality of event consumers, the operations including: monitoring one or more real-time event streams and, based on the monitoring, identifying a first event; adding, to at least one list data structure of the one or more list data structures, one or more list entries to notify two or more event consumers of the plurality of event consumers of the first event; further monitoring the one or more real-time event streams, and, based on the monitoring, identifying a further event associated with the first event; and responsive to identifying the further event associated with the first event, updating the one or more list entries to reflect the further event.

In some examples, the computer-readable medium may store instructions that, when executed by the processor of the computing system, cause the computing system to perform any of the methods described above.

### BRIEF DESCRIPTION OF THE DRAWINGS

Reference will now be made, by way of example, to the accompanying drawings which show example embodiments of the present application, and in which:

FIG. 1 is a block diagram illustrating an example event-driven system, in accordance with examples of the present disclosure;

FIG. 2 is a block diagram of an example computing system, which may be used to implement examples of the present disclosure;

FIG. 3 is a flowchart illustrating an example method for managing a list data structure, in accordance with examples of the present disclosure;

FIG. 4 is a block diagram of an example e-commerce platform, which may be an example implementation of the event-driven system of FIG. 1;

FIG. 5 is an example homepage of an administrator, which may be accessed via the e-commerce platform of FIG. 4; and

FIG. 6 is an example implementation of the method of FIG. 3 in the e-commerce platform of FIG. 4.

Similar reference numerals may have been used in different figures to denote similar components.

### DETAILED DESCRIPTION

To assist in understanding the present disclosure, an example event-driven system is first described. The event-driven system may be a distributed system, in which events are used to coordinate operations among disparate machines, subsystems or modules of the distributed system. In some examples, the event-driven system may be or may include a warehouse management system, a factory management system, a fulfillment system, an e-commerce system, etc.

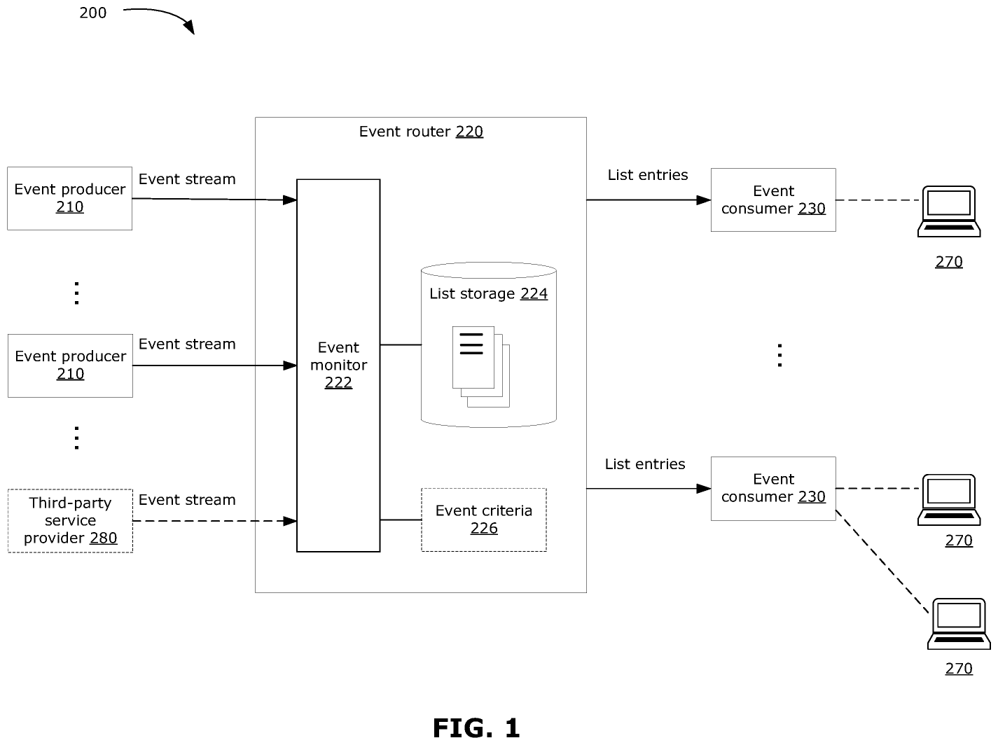

FIG. 1 illustrates an example event-driven system 200, in accordance with some examples of the present disclosure. The event-driven system 200 includes one or more event producers 210, at least one event router 220 and two or more event consumers 230.

In the example shown, the event-driven system 200 includes a plurality of event producers 210. Each event producer 210 generates respective events that are outputted in a respective real-time event stream (also referred to as an event channel). An event producer 210 may be, for example, a function or software module of the system 200 that generates events. An event (also referred to as an event message or a message) is a data object that contains information about an occurrence of interest to the system 200. An event may contain information about an occurrence external to the system 200 (e.g., user input) or an occurrence internal to the system 200 (e.g., a change of state of a module of the system 200). Each event producer 210 generates events into a respective real-time event stream, without having to direct each event to a particular event consumer 230 and without having to determine how each event should be processed.

The example of FIG. 1 includes an optional third-party service provider 280, which may be external to the event-driven system 200. The third-party service provider 280 may be an external source of events. The third-party service provider 280 may also provide events in a respective real-time event stream. There may be multiple third-party service providers 280. In the present disclosure, the third-party service provider 280 may be considered to be an event producer 210 that happens to be external to the system 200. There may not be any difference in how events from the third-party service provider 280 are processed compared to events from an event producer 210 that is internal to the system 200.

Although FIG. 1 illustrates separate real-time event streams for different event producers 210 (and optionally the third-party service provider(s) 280), in some examples events from different event producers 210 (including the optional third-party service provider(s) 280) may be provided in a common real-time event stream.

An event router 220 (also referred to as an event broker) is a software module of the event-driven system 200 that performs operations to monitor one or more real-time event streams (e.g., from respective one or more event producers 210, or one or more real-time event streams common to multiple event producers 210) and to notify one or more event consumers 230 of an event. In an example event-driven system 200 that uses a publisher/subscriber mechanism, the event router 220 performs operations to ensure events generated by a given event producer 210 (also referred to as a publisher) are notified to an event consumer 230 (also referred to as a subscriber) that is subscribed to events from that given event producer 210. A publisher/subscriber approach is one way for the event router 220 to identify the event consumer(s) 230 to be notified of an event, however the present disclosure is not limited to publisher/subscriber systems.

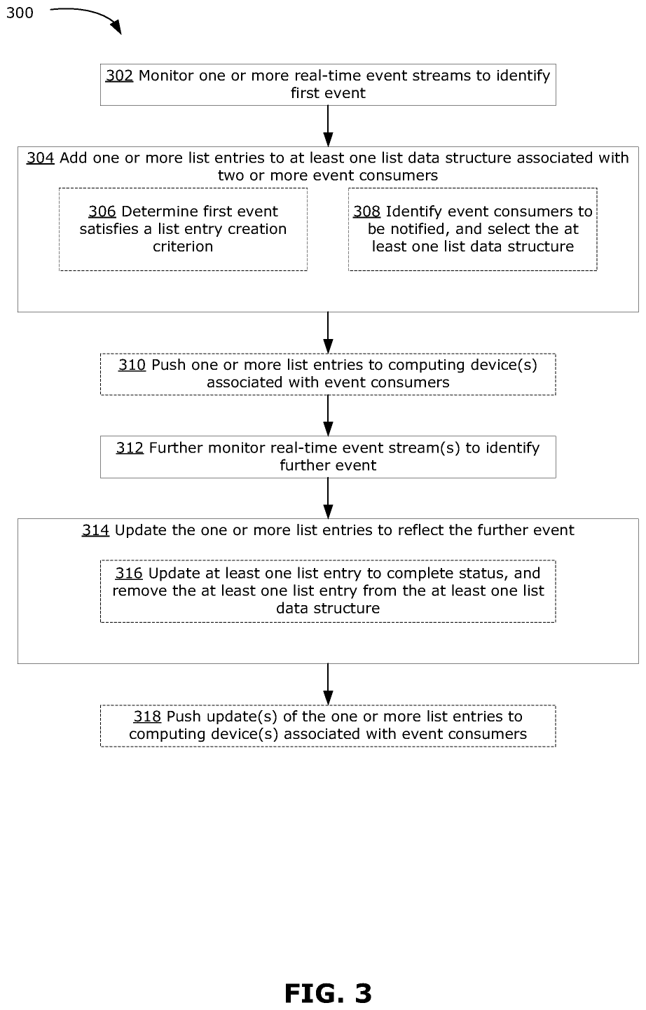

In the example of FIG. 1, the event router 220 implements an event monitor 222 that performs operations (discussed further below) to monitor the real-time event streams 210 and to populate list data structures maintained in a list storage 224. The list data structures store notifications as list entries and enable appropriate event consumers 230 to be notified of events. For example, when a new list entry is added to a given list data structure maintained in the list storage 224, the event router 220 may notify the event consumer(s) 230 associated with the given list data structure of the new list entry. In some examples, the list entry may be pushed to one or more computing devices 270 (e.g., personal computers, mobile devices, etc.) associated with each event consumer 230. The computing devices 270 may be considered to be external to the event-driven system 200. Further details will be provided with reference to FIG. 3 below.

The event router 220 may store one or more event criteria 226, which may be used to identify events of interest, to identify which list data structure is relevant to which event, to determine whether to create a new list entry when an event is identified, to determine how a list entry should be updated, etc. Examples will be described further below.

The event consumers 230 may be algorithms or software modules that process events (i.e., process the data contained in the events) to perform some function of the system 200. Each event consumer 230 may receive notifications corresponding to the list entries contained in at least one list data structure. A given event consumer 230 may be associated with one list data structure, meaning that given event consumer 230 is notified via list entries only from that one list data structure; another event consumer 230 may be associated with multiple list data structures, meaning that other event consumer 230 is notified via list entries across multiple different list data structures. A given list data structure may be associated with one event consumer 230, meaning that only one event consumer 230 is notified by that given list data structure; another list data structure may be associated with multiple event consumers 230, meaning that multiple event consumers 230 are notified by that other list data structure.

In some examples, the event-driven system 200 may be a distributed system. In such examples, one or more event producers 210 and/or one or more event consumers 230 may be physical machines (e.g., computing stations, sensors, Internet of Things (IoT) devices, etc.) that are physically separate from the event router 220. For example, the event-driven system 200 may be implemented over a network (e.g., a virtual private network (VPN) or intranet) and the event producers 210, event router 220 and event consumers 230 may be separate physical machines that communicate over the network.

The event-driven system 200 may be implemented using one or more computing systems. In particular, at least the event router 220 may be implemented using a computing system, such as a server or a central computing station.

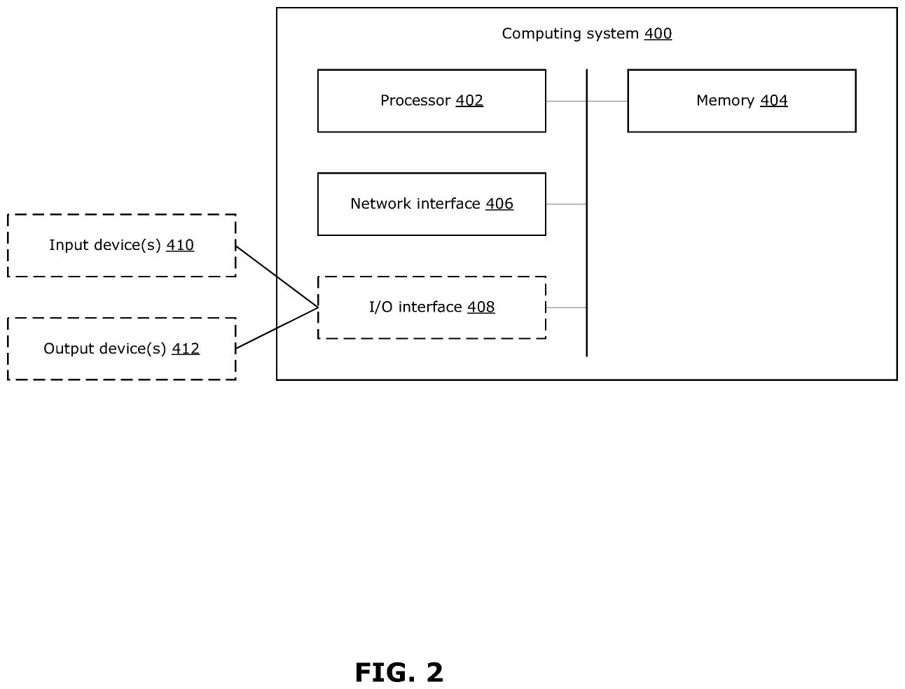

FIG. 2 illustrates an example computing system 400, which may be used to implement the event router 220 and/or the event-driven system 200.

The example computing system 400 includes at least one processor 402 and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to enable the event router 220, which is implemented by the computing system 400, to carry out examples of the methods, functionalities, systems and modules disclosed herein. In some examples, the list storage 224 may be implemented using the physical memory 404; in other examples, the list storage 224 may be implemented using an external physical memory that is in communication with the computing system 400.

The computing system 400 may also include at least one network interface 406 for wired and/or wireless communications with an external system and/or network (e.g., an intranet, the Internet, a P2P network, a WAN and/or a LAN). A network interface may enable the event router 220 to carry out communications (e.g., wireless communications) with systems external to the event-driven system 200, such as the third-party service provider(s) 280 and/or computing devices 270. In some examples, the event router 220 may use the network interface to communicate with one or more event producers 210 and/or one or more event consumers 230 (e.g., in the case where the event-driven system 200 is a distributed system).

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

Reference is again made to FIG. 1. In some example implementations of the event-driven system 200, the event consumers 230 do not produce events and do not communicate with other event consumers 230. However, when one event consumer 230 processes an event, this may result in an action or change that causes an event producer 210 to produce a new event. For example, if the event-driven system 200 is a digital media production platform, a first event might be produced by an event producer 210 when a user submits new media to be posted. A given event consumer 230 may be notified of this first event by the event router 220 and may perform operations to process the video, transcoding, compressing, generating captions or other time consuming tasks. The start of one or more of these operations may cause another event producer 210 to produce a further event in the real-time event stream (which may then be processed by another event consumer 230, and so forth). Notably, presence of the further event in the real-time event stream is an indirect indication that the first event has been processed. If the event router 220 has notified multiple event consumers 230 of the first event, then by monitoring the real-time event stream for the further event, the event router 220 may determine that the first event has been processed by at least one event consumer 230. The event router 220 may then update the notification to the multiple event consumers 230 (e.g., by updating the status of the notification to complete), to avoid another event consumer 230 processing the already processed first event.

FIG. 3 is a flowchart illustrating an example method 300 that may be performed by the event router 220. The method 300 may be performed to automatically manage one or more list data structures in order to notify event consumers 230 of monitored events in the real-time event stream.

At an operation 302, the event router 220 (e.g., using the event monitor 222) monitors one or more real-time event streams (e.g., containing events from one or more event producers 210) to identify a first event.

The event router 220 may monitor a real-time event stream containing events generated by any one or more of the event producers 210, which may be one or more of a plurality of distributed modules or machines in a distributed system. In some examples, the event router 220 may monitor a real-time event stream containing events generated by an external third-party service provider 280.

The event router 220 may identify the first event based on the first event satisfying at least one of the event criteria 226 maintained by the event router 220. For example, the event criteria 226 may include a predefined rule that events of a certain type (e.g., events related to a system critical task, events related to certain user accounts or certain event consumers 230, events marked as urgent, events produced by certain event producers 210, etc.) should be identified as requiring further action by an event consumer 230. In some examples, the event router 220 may identify the first event based on a defined pattern, sequence or history of prior events in the real-time event stream(s) (as defined by the event criteria 226). For example, a certain event criterion may cause the event router 220 to identify the first event when the first event is the third occurrence of the same event within a 1 s time period. In some examples, the first event may contain data (e.g., an urgency flag) that identifies itself as requiring action from the event router 220. Other such mechanisms for identifying the first event may be implemented by the event router 220.

At an operation 304, the event router 220 adds one or more list entries to at least one list data structure that is associated with two or more event consumers 230. This enables the two or more event consumers 230 to be notified of the first event. For example, the two or more event consumers 230 may be subscribed to the at least one list data structure in order to receive notifications corresponding to the list entries in the list data structure. The event router 220 may push list entries contained in the list data structure to all event consumers 230 that have subscribed to the list data structure, for example. In other examples, each event consumer 230 may pull list entries from a selected list data structure (e.g., a list data structure to which the event consumer 230 is subscribed).

Optionally, performing the operation 304 may include performing an operation 306 and/or an operation 308.

At the optional operation 306, the event router 220 determines that the first event satisfies a list entry creation criterion (e.g., as defined in the event criteria 226 maintained by the event router 220). At least one list entry may be added to the at least one list data structure based on the list entry creation criterion being satisfied. The list entry creation criterion may be the same event criterion that was used to identify the first event at the operation 302. For example, an event criterion may be a defined rule that causes the event router 220 to create and add a new list entry to the at least one list data structure when a particular first event is identified in a real-time event stream. In other examples, the list entry creation criterion may be separate and independent from any event criterion that may (or may not) be used to identify the first event. For example, the first event may contain data identifying itself as requiring action from the event router 220, and the event router 220 may further use a list entry creation criterion stored in the event criteria 226 to determine whether a list entry should be created corresponding to the first event.

At the optional operation 308, the event router 220 identifies the two or more event consumers 230 to be notified of the first event. The at least one list data structure (to which the one or more list entries are added) may be selected based on the identification of the two or more event consumers 230.

For example, the event-driven system 200 may be part of a platform that hosts online services (or online instances). There may be one or more user account associated with a given online service. In such examples, the one or more real-time event streams may contain events that are specific to one or more particular online services. The event router 220 may identify the first event as being associated with a particular online service (e.g., based on data contained in the event identifying the online service), and may further identify the two or more event consumers 230 as being associated with user accounts of the particular online service and that these event consumers 230 should be notified of the first event. The event router 220 may then identify the at least one list data structure as being associated with the event consumers 230 that require notification, and thus add the one or more list entries to the identified at least one data structure. In other examples, the event router 220 may identify the first event as being associated with a particular online service, and may further identify the at least one list data structure as being associated with the particular online service (without necessarily identifying the user accounts associated with the particular online service) and thus add the one or more list entries to the identified at least one data structure.

The event router 220 may use various defined criteria and/or rules to identify the two or more event consumers 230 to be notified of the first event. For example, the first event may contain data identifying one or more event consumers 230 that should be notified; the first event may contain data associated with one or more user accounts that should be notified and the event router 220 may identify the event consumer(s) 230 associated with those user account(s); the first event may contain data associated with one or more online services that should be notified and the event router 220 may identify the event consumer(s) 230 associated with those online service(s); an event criterion may identify event consumer(s) 230 that should be notified of a particular type of event; etc.

In some examples, the event router 220 may add the one or more list entries to a master list data structure and one or more child list data structures may be generated or derived from the master list data structure. The child list data structure(s) may be used to notify the event consumers 230. Each child list data structure may be populated with list entries pulled from the master list data structure, but not necessarily all list entries of the master list data structure. Each child list data structure may be populated with a different (or overlapping) subset of list entries from the master list data structure.

For example, a master list data structure may be associated with an online service. User accounts associated with the online service may be associated with the event consumers 230. Different user accounts may have different settings to cause the user accounts to be notified of different events (e.g., based on set permissions of each user account, based on user preferences of each user account, based on user role of each user account, etc.). A user account may be associated with a particular event consumer 230 and the particular child list data structure that is associated with that event consumer 230 may be populated with a subset of list entries from the master list data structure, where the subset is selected based on the settings of the user account.

The event router 220 may determine the type and/or the content of the one or more list entries that are added to the at least one list data structure. In some examples, the event router 220 may extract data from the first event (e.g., type data, timestamp data, label data, etc.) and use the extracted data to create and populate the content of a list entry to be added to the at least one list data structure.

Regardless of how the operation 304 is performed (e.g., including optional operation 306, optional operation 308, or both), following the operation 304 an optional operation 310 may be performed.

At the optional operation 310, the one or more list entries added to the at least one list data structure may be pushed to one or more computing devices 270.

For example, a computing device 270 (e.g., a personal computer, a mobile device, etc.) may be associated with a given event consumer 230, so that notifications received by the given event consumer 230 are outputted at the computing device 270. This may enable a user to receive the notifications of the given event consumer 230. For example, a user may use the notifications to monitor the operations of the event-driven system 200 (e.g., to ensure that the given event consumer 230 is processing notifications and performing system tasks appropriately). In some examples, a user may, after receiving notifications via a computing device 270 associated with the given event consumer 230, perform a system-related action or task.

At an operation 312, the event router 220 further monitors the one or more real-time event streams to identify a further event associated with the first event. The event router 220 may identify the further event to be associated with the event based on one or more stored event criteria 226; based on a criterion defined by the first event (e.g., the first event may itself include data identifying the further event); or based on the further event having data in common with the first event (e.g., associated with the same system task, associated with the same online service, etc.). The event router 220 may store predefined event flows that define expected relationships between events. For example, a predefined event flow may indicate that after the first event has occurred, a particular further event should subsequently occur. The event router 220 may, in accordance with the predefined event flow, monitor the one or more real-time event streams for the presence of the further event after the first event has occurred.

The presence of the further event in the one or more real-time event streams may indicate that the first event has been processed or is being processed by at least one of the two or more event consumers 230 (which were notified by the addition of the one or more list entries at operation 304). For example, the event router 220 may store a predefined event flow indicating that the further event is produced by an event producer 210 when the first event has been processed by an event consumer 230. For example, it may be expected that processing of the first event by an event consumer 230 requires performance of a certain system-related task that causes a change that an event producer 210 reacts to by producing the further event. Thus, when the event router 220 identifies the presence of the further event in the one or more real-time event stream, the event router 220 is able to infer that the first event has been processed.

At an operation 314, in response to identifying the further event, the event router 220 updates at least one of the one or more list entries to reflect the further event. Updating the at least one list entry (which corresponds to a notification of the first event) may be an indication that the first event has been processed or is being processed. Updating the at least one list entry may include updating a label or metadata associated with the at least one list entry. For example, metadata indicating the status of the at least one list entry may be updated to indicate a “complete” status, an “in-progress” status, etc. In some examples, updating the at least one list entry may include updating the data contents of the list entry, for example to include a timestamp of the further event.

Updating the at least one list entry may cause corresponding notifications at the two or more event consumers 230 to be updated accordingly. In this way, all of the two or more event consumers 230 can be notified that the first event has been processed or is being processed. If one of the two or more event consumers 230 has processed the first event, then the other(s) of the two or more event consumers 230 are thus informed that the first event has been processed and thus redundant processing of the first event is avoided.

In some examples, if one or more list entries were added to two or more list data structures (at previous operation 304), then at the operation 314, each list entry corresponding to notification of the first event may be updated across all of the two or more list data structures. This may ensure that all event consumers 230 that were previously notified of the first event are now updated with information that the first event has been processed or is being processed.

It may be noted that, in the case where the event-driven system 200 is a distributed system (where event producers 210 may be independent machines separate from the event router 220), the event router 220 is able to monitor for the presence of the further event in order to infer that the first event has been processed, without having to query any of the disparate machines for its processes. Similarly, if a third-party service provider 280 is the source of the first event or further event, the event router 220 does not need to explicitly send a query to the third-party service provider 280 in order to infer that the first event has been processed. In this way, latency of the overall event-driven system 200 may be reduced and throughput of the system 200 may be improved.

Optionally, performing the operation 314 may include performing an operation 316.

At the optional operation 316, at least one list entry may be updated to a complete status, as discussed previously. In response to the list entry being updated to a complete status, the list entry may be removed (e.g., deleted) from the list data structure. This may cause corresponding notifications at the two or more event consumers 230 to be removed. This may provide the advantage that if a given event consumer 230 had not yet processed the notification (e.g., the event consumer 230 was in the middle of a previous process preventing the event consumer from processing the notification), that given event consumer 230 need not process that notification at all. That is, the given event consumer 230 may not need to use resources required to process a notification that is no longer relevant because that notification is removed by the event router 220.

Following the operation 314, an optional operation 318 may be performed. The optional operation 318 may be performed if the optional operation 310 was previously performed, for example.

At the optional operation 318, one or more updates to the one or more list entries are pushed to the one or more computing devices 270 associated with the two or more event consumers 230. Thus, a user who is using a computing device 270 to monitor notifications at one of the two or more event consumers 230 may be notified that the first event has been or is being processed.

In contrast to some conventional event-driven systems, the present disclosure may enable the event router 220 to not only notify event consumers 230 of an event produced by an event producer 210, but also to update the notification to event consumers 230. The event router 220 implements logic to recognize that the further event is related to the first event and that the further event represents the first event has been or is being processed. That is, the event router 220 is configured to recognize that the further event is related to the first event and, instead of further notifying event consumers 230 of the further event (and thus requiring the event consumers 230 to process both the notification of the first event as well as the notification of the further event), the event router 220 performs operations to update the notification of the first event to reflect the further event.

Further, the event router 220 performs operations to ensure that the notification is updated to reflect the further event for multiple event consumers 230 that were previously notified of the first event. If there are multiple list data structures that contain a list entry corresponding to the first event, the list entry is updated to reflect the further event across all of the multiple list data structures. This helps to ensure that all event consumers 230 that were notified of the first event are able to be updated that the first event has been or is being processed.

The disclosed event router 220 may be useful in implementations in which there may be multiple event consumers 230 that are equally capable of processing the same event to perform the same task. Consider the example where the event-driven system 200 is in an automated or semi-automated warehouse. In such an implementation, an event producer 210 may be an order system and event consumers 230 may be robot controllers that each manage a group of mobile robots within the warehouse (e.g., the warehouse may be large, such that it becomes more efficient for separate groups of robots to be controlled by separated controllers). Events generated by the order system may identify a product to be picked to fulfill an order. Each robot controller may be capable of processing such events, where processing an event may involve the robot controller sending a specific robot to pick the listed product. In such a scenario, the event router 220 as disclosed herein may, in response to a first event (e.g., identification of a product to be picked) in a real-time event stream from the order system, add a list entry to a list data structure that is used to notify the robot controllers of the first event. There may be multiple robot controllers that can control a robot to pick the identified product (e.g., the product may be located in an area reachable by robots controlled by the different robot controllers), and it would be problematic if each robot controller controlled a robot to pick the same product. Instead, one robot controller that is first to process the added list entry may send a robot under its control to pick the identified product. Sending of the robot may be logged as an event in a real-time event stream. The event router 220 may identify this as the further event that is related to the first event and may, for example, update the status of the first event from an order that needs to be fulfilled to an order that is being fulfilled by another robot controller. The event router 220 may update the list entry in the list data structure to reflect the further event (e.g., by changing the status of the first event), and thus other robot controllers are informed that the first event has been processed (and that there is no need to send a robot to pick the same product). Once the robot controller has completed fulfilling the item, it may send another event indicating that the item has been fulfilled, at which time it may be removed from the list data structure. In this example, an order may consist of multiple items, and events may update the state of entire orders, or items within the order.

Unlike some conventional event-driven systems, in which the event router 220 serves to route events to event consumers 230 without further analysing the events, the present disclosure provides added capabilities in that the event router 220 may intelligently provide updates to the event consumers 230 if a previously notified event is now out of date (e.g., has been processed). The use of a list data structure to notify event consumers 230 may mean that the event router 220 is able to both update the notifications within the list data structure and remove notifications within the list data structure. This is not possible in many conventional event-driven systems because a conventional event router does not maintain any list data structure or any record of the notifications sent to event consumers 230.

In some examples, the event-driven system 200 may be, may be implemented in, or may include an e-commerce platform. An example of an e-commerce platform is described below. However, it should be understood that this discussion is only for the purpose of illustration and is not intended to be limiting as to the nature of an e-commerce system or event-driven system with which the subject matter of the present application may be implemented. Further, it should be understood that the present disclosure may be implemented in other contexts, and is not necessarily limited to implementation in an e-commerce platform. For example, the present disclosure may be implemented in the context of any online platform, any distributed system, or any system using an event-driven architecture without necessarily supporting any e-commerce. Other such possibilities are contemplated within the scope of the present disclosure.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

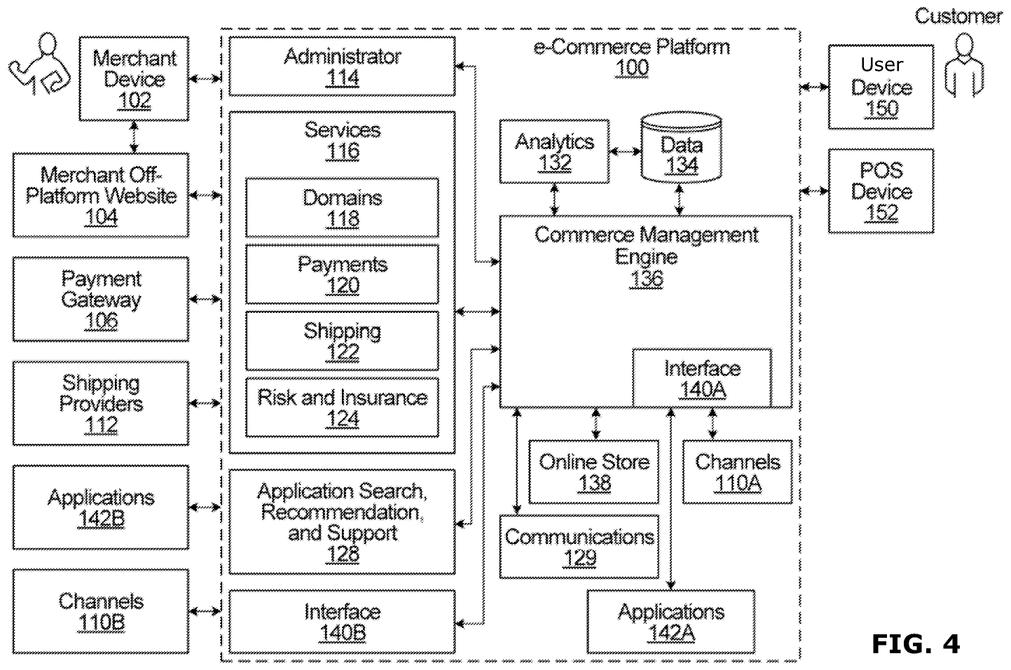

FIG. 4 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 4, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (Saas), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

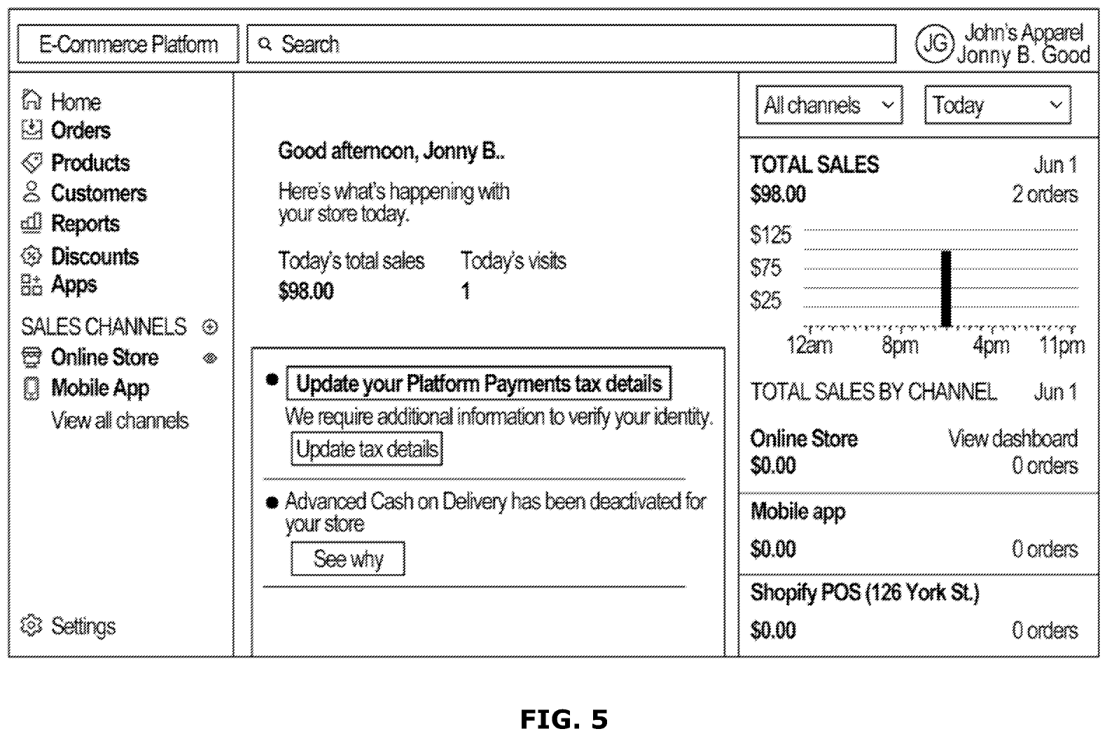

FIG. 5 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalogue, managing orders, and/or the like. In some embodiments, the merchant may be able to access the different sections of the administrator 114 by using a sidebar, such as the one shown on FIG. 3. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 2, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales) (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

Having discussed an example e-commerce platform, the event router, as disclosed herein, as may be implemented on the e-commerce platform to enable an event-based mechanism for carrying out functions related to the e-commerce platform. The event-driven system disclosed herein may be implemented on the e-commerce platform to enable more efficient use of resources by the e-commerce platform, for example.

In the example e-commerce platform 100, various components such as services 116, applications 142A-B, payment gateway 106, shipping providers 112, analytics 132, etc. may function in the role of event producers or event consumers. That is, various software modules (whether internal to the e-commerce platform 100 or external to and in communication with the e-commerce platform 100) may produce events, which may in turn be processed by other software modules. An embodiment of the event router as disclosed herein may be used to mediate between event producers and event consumers of the e-commerce platform 100, by managing list data structures that are used to notify event consumers.

Events may be related to functioning of an online store 138. For example, normal operations of an online store 138 may be driven by inventor-related events (e.g., low inventory event, new inventory event, etc.), order-related events (e.g., new order event, order complete event, etc.), finance-related events (e.g., credit card denied event, payment approved event, etc.), among others. Such events may be routed by the event router 220 to generate appropriate notifications.

For example, an online store 138 may be associated with multiple user accounts corresponding to users who perform tasks to manage the online store 138. Each user account may correspond to a respective event consumer that can process events associated with the online store 138. Different user accounts may have different permissions and/or user preferences, which determine the events that each user account should be notified of. For example, a higher-level user account (e.g., store owner account) may have full permission to access store information and may be notified of events using a first list data structure that contains list entries based on all events requiring action. A lower-level user account (e.g., store employee account) may have limited permissions and may be notified of events using a second list data structure that contains list entries pertaining to limited types of events (e.g., only inventory-related events, and not finance-related events).

There may be multiple user accounts that are notified of the same first event (e.g., the multiple user accounts correspond to multiple event consumers that are all being notified via a list entry from the same list data structure) and may all be capable of processing the same first event. The event router 220 may monitor real-time event streams to identify if there is a further event related to the first event, which may indicate that one of the user accounts has processed the first event. When the further event is identified in the real-time event stream, the event router 220 may update the list entry corresponding to the first event to reflect that the further event has occurred. The multiple user accounts may thus be informed that the first event has been processed and thus no further processing is required.

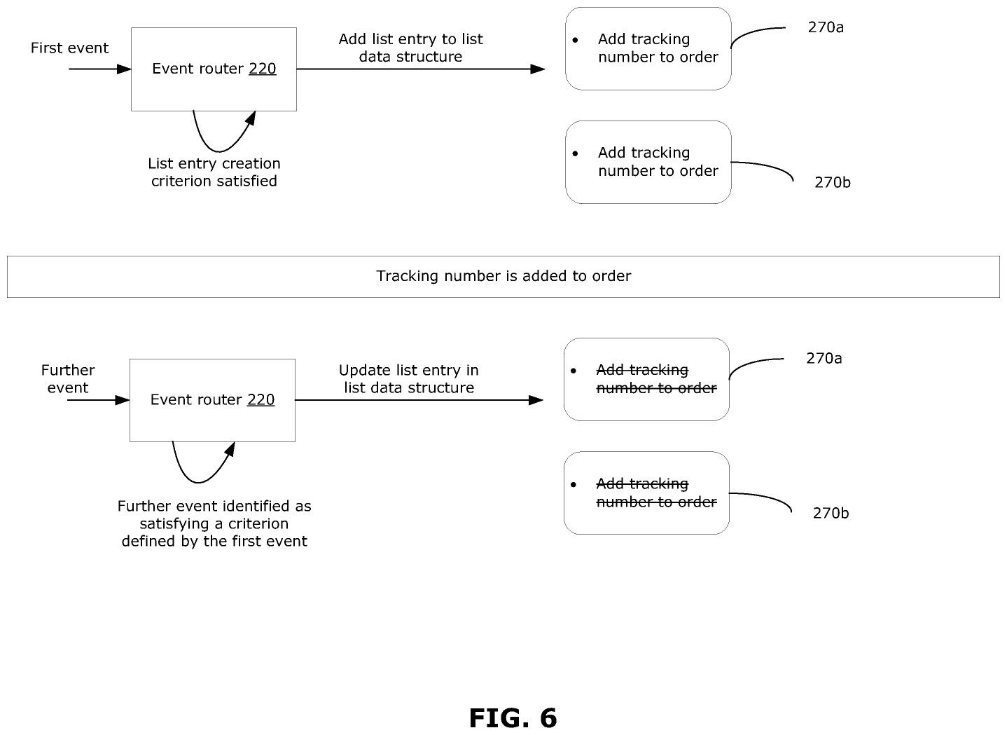

FIG. 6 illustrates an example of how the event router 220 may manage a list data structure in order to notify multiple user accounts associated with an online store 138 (not shown in FIG. 6).

In this simplified example, there are two user accounts associated with a given online store 138. Each user account corresponds to an event consumer 210. Each user account is also associated with a respective computing device 270a, 270b that may be used by a user of each user account to view notifications routed to the respective event consumer 210.

The event router 220 identifies a first event in a real-time event stream, where the first event is associated with the online store 138 (e.g., the first event contains data identifying the online store 138, such as a store identifier). The first event satisfies a list entry creation criterion maintained by the event router 220, and the event router 220 adds a corresponding list entry to a list data structure to notify the user accounts associated with the online store 138. In this example, the first event requires a tracking number to be added to an order. Each user account is notified by the list entry, for example by having a notification being displayed on each computing device 270a, 270b.

The first event may include data defining an event criterion, which the event router 220 may use to identify a further event related to the first event. For example, the first event may define a tracking number updated event to be the further event that enables the first event to be updated to a complete status. The event router 220 may store this event criterion.

Some time later, a tracking number is added to the order. This task may be performed by one of the user accounts that was notified. Notably, there is no need for any of the user accounts to explicitly take ownership of the task. The completion of the task causes a further event (e.g., tracking number updated event) to be produced in the real-time event stream. The event router 220 may identify the further event as satisfying the criterion that was defined by the first event, and may update the list entry in the list data structure to reflect the further event (e.g., to indicate the complete status). This update is reflected in the notification displayed on each computing device 270a, 270b, for example by the notification being struck out or removed.

In this way, the present disclosure enables the event router 220 to manage list data structures, such that notifications may be appropriately updated across two or more event consumers. This provides a technical advantage that inefficiencies can be avoided, without requiring event consumers to explicitly coordinate task completion among themselves. The need for explicit indication of task completion and task ownership among event consumers can also be avoided, thus reducing latency in the system.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computing system comprising:
a physical memory storing one or more list data structures for storing notifications for a plurality of event consumers; and
a processing unit configured to execute computer-readable instructions to cause the computing system to perform operations for managing the one or more list data structures, the operations including:
monitoring one or more real-time event streams and, based on the monitoring, identifying a first event;
adding, to at least one list data structure of the one or more list data structures, one or more list entries to notify two or more event consumers of the plurality of event consumers of the first event;
further monitoring the one or more real-time event streams, and, based on the monitoring, identifying a further event associated with the first event; and
responsive to identifying the further event associated with the first event, updating the one or more list entries to reflect the further event.

2. The computing system of claim 1, wherein the one or more list entries are added to at least two list data structures of the one or more list data structures, and wherein updating the one or more list entries comprises updating the one or more list entries across all of the at least two list data structures.

3. The computing system of claim 1, wherein the operations further comprise:
identifying the two or more event consumers to be notified of the first event; and
selecting the at least one list data structure to which the one or more list entries are added, based on identification of the two or more event consumers.

4. The computing system of claim 1, wherein the one or more list entries are added to the at least one list data structure in response to determination that the first event satisfies at least one defined list entry creation criterion.

5. The computing system of claim 1, wherein at least one list entry of the one or more list entries is updated to a complete status, and the at least one list entry is removed from the at least one list data structure responsive to the complete status.

6. The computing system of claim 1, wherein the one or more real-time event streams contain events generated by any one or more of a plurality of distributed modules in communication with the computing system.

7. The computing system of claim 6, wherein at least one of the plurality of distributed modules is a third-party module external to and in communication with the computing system, and wherein identifying the further event and updating the one or more list entries are performed in absence of a query to the third-party module.

8. The computing system of claim 1, wherein the first event is associated with an online service of the computing system, wherein the at least one list data structure is associated with the online service, and wherein the two or more event consumers are associated with respective two or more user accounts associated with the online service.

9. The computing system of claim 8, wherein a master list data structure is associated with the online service, and each list data structure associated with a respective user account is generated from the master list data structure.

10. The computing system of claim 1, wherein the operations further comprise:
pushing the one or more list entries, to one or more computing devices associated with each of the two or more event consumers;
wherein updating the one or more list entries includes pushing respective one or more updates of the one or more list entries to the one or more computing devices associated with each of the two or more event consumers.

11. A computer-implemented method for managing one or more list data structures storing notifications for a plurality of event consumers, the method comprising:
monitoring one or more real-time event streams and, based on the monitoring, identifying a first event;
adding, to at least one list data structure of the one or more list data structures, one or more list entries to notify two or more event consumers of the plurality of event consumers of the first event;
further monitoring the one or more real-time event streams, and, based on the monitoring, identifying a further event associated with the first event; and
responsive to identifying the further event associated with the first event, updating the one or more list entries to reflect the further event.

12. The method of claim 11, wherein the one or more list entries are added to at least two list data structures of the one or more list data structures, and wherein updating the one or more list entries comprises updating the one or more list entries across all of the at least two list data structures.

13. The method of claim 11, further comprising:
identifying the two or more event consumers to be notified of the first event; and
selecting the at least one list data structure to which the one or more list entries are added, based on identification of the two or more event consumers.

14. The method of claim 11, wherein the one or more list entries are added to the at least one list data structure in response to determination that the first event satisfies at least one defined list entry creation criterion.

15. The method of claim 11, wherein at least one list entry of the one or more list entries is updated to a complete status, and the at least one list entry is removed from the at least one list data structure responsive to the complete status.

16. The method of claim 11, wherein the one or more real-time event streams contain events generated by any one or more of a plurality of distributed modules, and wherein identifying the further event and updating the one or more list entries are performed in absence of a query to the plurality of distributed modules.

17. The method of claim 11, wherein the first event is associated with an online service, wherein the at least one list data structure is associated with the online service, and wherein the two or more event consumers are associated with respective two or more user accounts associated with the online service.

18. The method of claim 17, wherein a master list data structure is associated with the online service, and each list data structure associated with a respective user account is generated from the master list data structure.

19. The method of claim 11, further comprising:
pushing the one or more list entries, to one or more computing devices associated with each of the two or more event consumers;
wherein updating the one or more list entries includes pushing respective one or more updates of the one or more list entries to the one or more computing devices associated with each of the two or more event consumers.

20. A computer-readable medium storing instructions that, when executed by a processor of a computing system, cause the computing system to perform operations for managing one or more list data structures storing notifications for a plurality of event consumers, the operations including:
monitoring one or more real-time event streams and, based on the monitoring, identifying a first event;
adding, to at least one list data structure of the one or more list data structures, one or more list entries to notify two or more event consumers of the plurality of event consumers of the first event;
further monitoring the one or more real-time event streams, and, based on the monitoring, identifying a further event associated with the first event; and
responsive to identifying the further event associated with the first event, updating the one or more list entries to reflect the further event.
